(19) United States
(12) Patent Application Publication
(10) Pub. No.: US 2016/0359364 A1
(43) Pub. Date: Dec. 8, 2016

(54) UTILIZING A LOAD FOR OPTIMIZING ENERGY STORAGE SIZE AND OPERATION IN POWER SYSTEMS REGULATION APPLICATIONS

(71) Applicant: NEC Energy Solutions, Inc., Westborough, MA (US)

(72) Inventor: Nadim H. Kanan, Northborough, MA (US)

(21) Appl. No.: 15/172,604

(22) Filed: Jun. 3, 2016

Related U.S. Application Data
(60) Provisional application No. 62/170,769, filed on Jun. 4, 2015.

(51) Int. Cl. H02J 13/00; G05B 15/02; G05F 1/66

(52) U.S. Cl. CPC H02J 13/0096; G05F 1/66; G05B 15/02

(57) ABSTRACT

An energy storage system that delivers electrical energy to and absorbs electrical energy from a power grid comprises a storage bank configured to store electrical energy received from the power grid through a conversion unit, and to deliver stored electrical energy through the conversion unit. The energy storage bank may be characterized by an associated parameter. The energy storage system may further include a load configured to dissipate electrical energy received from the power grid through a load gate, and a control unit operatively coupled to the conversion unit and the load gate. The control unit may be configured to control electrical energy flowing from the power grid to the energy storage bank and to the load, and electrical energy flowing from the energy storage bank to the power grid, as a function of a signal from the power grid and the parameter associated with the energy storage bank.

### RELATED APPLICATION

This application claims the benefit of U.S. Provisional Application No. 62/170,769, filed on Jun. 4, 2015. The entire teachings of the above application are incorporated herein by reference.

### BACKGROUND

A power grid may be used to supply alternating current (AC) electrical power to consumers across a wide geographical area. The AC electrical power alternates at a nominal frequency, for example 50 or 60 Hz.

Varying demands placed on the power grid may cause characteristic parameters of the power grid (e.g., voltage and/or current and/or frequency) to fluctuate. Energy storage or energy dissipative components may be used to deliver energy to or absorb energy from the power grid to mitigate the parameter fluctuation. The following description relates to fluctuations of the power grid frequency, although the concepts described herein may be applied to fluctuations of other power grid parameters.

Generators supplying the electrical power to the power grid spin at an angular rate related to the frequency of the distributed power. A power demand placed on a generator may cause its angular rate to decrease slightly, which causes the frequency of the distributed power to decrease proportionally. Similarly, a power demand removed from the generator may cause its angular rate to increase slightly, which cause the frequency of the distributed power to increase slightly. An example of such a power demand may be a large factory or other industrial enterprise beginning operations in the morning or ending operations in the evening.

A frequency control system local to the generator (local frequency regulation) works to maintain the frequency of the distributed power at the nominal frequency (e.g., 50 or 60 Hz). But the local frequency regulation typically has a slow response time. A reserve energy source may be used to compensate for such a power demand more quickly than the local frequency regulation.

Spinning reserves may be used to deliver reserve energy. But in order to provide a fast response, the spinning reserves need to be constantly fueled so that they will be spinning whenever needed. Additionally, spinning reserves can only supply energy to the grid and therefore only correct low frequency conditions. They cannot absorb energy from the grid to correct high frequency conditions.

Storage elements (e.g., batteries) can deliver or absorb reserve energy to correct for both high and low frequency conditions (i.e., above and below nominal frequency), and are more economical since storage elements do not require fuel to keep them available as do fossil-fuel powered spinning reserves.

FIG. 1 illustrates an example of a storage based frequency regulation station, herein referred to as an energy storage system. An energy conversion unit 102 connects a power grid 104 comprising components such as loads, generators and transformers, to a set of energy storage elements 106. The energy conversion unit 102 provides, among other functions, conversion between the AC domain of the power grid to the direct current (DC) domain of the energy storage elements. A control unit 108 provides deliver and absorb commands to the conversion unit 102, the commands derived from system measurements (e.g., frequency of power grid) and/or tele-communicated power dispatch commands from authorities maintaining the power grid.

An example of a power system regulation function is a frequency response application. In such an application, the power output amount and direction is governed by the frequency of the power grid, as a function of an agreed-upon requirement. For instance, if the power grid frequency goes below a certain threshold (e.g., 50Hz), the energy storage system is required to respond with a positive power amount (deliver energy to the power grid) that is proportional to the frequency deviation. Similarly, if the frequency goes above the threshold, the energy storage system is required to respond with a negative power amount (absorb energy from the power grid). FIG. 2 illustrates an example frequency response requirement 202, which specifies an amount of power to be delivered or absorbed (relative to a maximum power capability) versus power grid frequency deviation. The unshaded region 204a designates the power grid frequency range for which the energy storage system delivers power to the power grid, and the shaded region 204b designates the power grid frequency range for which the energy storage system absorbs power from the power grid. An energy storage bank, the capacity of which is shown conceptually by battery symbols 206a, 206b, provides energy delivery and absorption services of the energy storage system. It should be understood that the battery symbols 206a, 206b are not intended to be construed as the configuration of actual cells in the energy storage bank. The energy storage capacity portion 206a is available to absorb energy from the power grid while the power grid frequency is in the frequency range 204a, and energy storage capacity portion 206b is available to be delivered to the power grid while the power grid frequency is in the frequency range 204b.

If the power grid frequency deviations were equally probable to happen in both directions (positive or negative), and the same amount of energy is required for these frequency deviations events, then the system state of charge (SOC) has to be managed to stay around 50%, as shown in FIG. 2B. In other words, the energy storage system attempts to keep 50% of its capacity ready to be discharged to the power grid and the remaining 50% of its capacity ready to abosorb energy from the power grid.

As an example, if a 10 MW/10 MWh energy storage system is to operate per the frequency response requirement 202 of FIG. 2, then it may maintain its SOC at 50% so that 5 MWh of the energy storage system capacity can be discharged into the grid or 5 MWh of the energy storage system capacity can be absorbed from the grid depending on the grid conditions or dispatch commands from the grid operator.

Thus, the fact that the distributed frequency regulation system has to be able to deliver or absorb electrical energy from the power grid imposes constraints on the minimum frequency regulation system size. The system needs to have enough storage capacity to deliver or absorb a predetermined energy amount resulting from change in power grid frequency. The predetermined energy amounts are amounts agreed upon by the distributed frequency regulation system operators and the power grid operators (such as the 10 MW/10 MWh example above).

### SUMMARY OF THE INVENTION

The described embodiments are directed to a system for and method of delivering electrical energy to and absorbing electrical energy from a power grid, with a combination of energy storage components and energy dissipative components. The energy absorbed by the energy dissipative components depends on certain aspects of the energy storage components. This dependency may reduce overall system size by reducing the energy storage capacity required by energy storage components. Further, this dependency may improve the state of health of the energy storage components by keeping certain parameters associated with the energy storage components out of high-risk value ranges, or reducing the amount of time those parameters occupy the high-risk value ranges.

An energy storage system constructed according to the described embodiments may be characterized by a particular energy delivery/absorption requirement, which is generally contracted or otherwise agreed upon with a power grid authority (e.g., an ISO—Independent Service Operator). For example, referring to the previously mentioned 10 MW/10 MWh energy storage system, agreed upon energy storage system requirements may include a 10 MW/10 MWh total capacity, a requirement to charge and discharge for 30 minutes on scheduled compliance tests, a requirement to respond for at least 30 minutes if the power grid frequency falls outside of the ±100 mHz band (i.e., between 49.9 Hz and 50.1 Hz), and a response curve such as that shown in FIG. 2.

In one aspect, the invention is an energy storage system that delivers electrical energy to and absorbs electrical energy from a power grid. The energy storage system may comprise a storage bank configured to store electrical energy received from the power grid through a conversion unit, and to deliver stored electrical energy to the power grid through the conversion unit, the energy storage bank being characterized by a parameter associated with the energy storage bank The energy storage system may further comprise a load configured to dissipate electrical energy received from the power grid through a load gate, and a control unit operatively coupled to the conversion unit and the load gate. The control unit may be configured to control electrical energy flowing from the power grid to the energy storage bank and to the load, and electrical energy flowing from the energy storage bank to the power grid, as a function of (i) the parameter associated with the energy storage bank, and (ii) one of a signal from the power grid and the power grid operator's dispatch command.

In one embodiment, the storage bank may be characterized by a storage bank capacity, the load is characterized by a load dissipation ability, and the storage bank capacity is determined as a function of the load dissipation ability.

In another embodiment, the control unit may cause at least one of the storage bank and the load to receive electrical energy from the power grid when the signal from the power grid or the power grid operator's dispatch command conveys a requirement to absorb electrical energy, and the control unit causes the storage bank to deliver electrical energy to the power grid when the signal from the power grid or the power grid operator's dispatch command conveys a requirement to deliver electrical energy.

In another embodiment, the control unit may be configured to, when the signal from the power grid conveys a requirement to absorb electrical energy, cause the electrical energy to be absorbed from the power grid to the storage bank through the conversion unit when the parameter associated with the energy storage bank does not exceed a parameter threshold, and cause the electrical energy to be absorbed from the power grid to the load through the load gate when the parameter associated with the energy storage bank exceeds the parameter threshold.

In one embodiment, the control unit may be configured to, when the signal from the power grid conveys a requirement to absorb electrical energy, cause the electrical energy to be absorbed from the power grid to the storage bank N percent of the time, where N is a number between 0 and 100, and cause the electrical energy to be absorbed from the power grid to the load 100 minus N percent of the time.

In another embodiment, the control unit may be further configured to control electrical energy flowing from the power grid to the energy storage bank and to the load, and electrical energy flowing from the energy storage bank to the power grid, as a function of two or more parameters associated with the energy storage bank.

In one embodiment, the parameter associated with the energy storage bank may be state of charge of the storage bank. In another embodiment, the parameter associated with the energy storage bank may be temperature of the storage bank. In another embodiment, the parameter associated with the energy storage bank may be total throughput of the system. In another embodiment, the parameter associated with the energy storage bank may be charge-discharge cycles experienced by the storage bank. In another embodiment, the parameter associated with the energy storage bank may be charge rate of the storage bank.

In one embodiment, the signal from the power grid may be a dispatch command from the power grid operator indicating one of (i) absorb and (ii) deliver. In another embodiment, the signal from the power grid may be an alternating power signal at an interface with the power grid. The control unit may be configured to interpret the alternating power signal according to an energy response requirement that specifies an amount of power the system has to absorb and an amount of power the system has to deliver as a function of a frequency associated with the alternating power signal.

In one embodiment, at least a portion of the load may comprise a useful load that absorbs the received electrical energy by accomplishing a useful function.

In another aspect, the invention is a method of transferring energy to and from a power grid. The method may comprise providing electrical energy to the power grid from an energy storage bank when one of a signal from the power grid and the power grid operator's dispatch command indicates a requirement to deliver electrical energy. The method may further comprise, when the one of the signal from the power grid and the power grid operator's dispatch command indicates a requirement to absorb electrical energy, performing, as a function of a parameter associated with the energy storage bank, at least one of (i) conveying electrical energy from the power grid to the energy storage bank and (ii) conveying electrical energy from the power grid to an electrical load.

One embodiment may further comprise interpreting the signal from the power grid according to an energy response requirement that specifies, as a function of a frequency associated with the power grid, an amount of energy to be absorbed and an amount of energy to be delivered.

Another embodiment may further comprise the method may further comprise conveying electrical energy to a load that absorbs received electrical energy by accomplishing a useful function.

Another embodiment may further comprise conveying electrical energy from the power grid to the load when the control signal from the power grid or the power grid operator's dispatch command indicates a requirement to absorb electrical energy, and a state of charge of the energy storage bank exceeds a threshold.

One embodiment may further comprise conveying electrical energy from the power grid to the load when the control signal from the power grid or the power grid operator's dispatch command indicates a requirement to absorb electrical energy, and a temperature of the energy storage bank exceeds a threshold.

One embodiment may further comprise conveying electrical energy from the power grid to the load when the control signal from the power grid or the power grid operator's dispatch command indicates a requirement to absorb electrical energy, and a total throughput of the energy storage bank exceeds a threshold.

Another embodiment may further comprise conveying electrical energy from the power grid to the load when the control signal from the power grid or the power grid operator's dispatch command indicates a requirement to absorb electrical energy, and a number of charge-discharge cycles of the energy storage bank exceeds a threshold.

Another embodiment may further comprise conveying electrical energy from the power grid to the load when the control signal from the power grid or the power grid operator's dispatch command indicates a requirement to absorb electrical energy, and a rate of electrical energy conveyances to the storage bank exceeds a threshold.

In another aspect, the invention is a control unit that is associated with a storage bank, a load, a conversion unit, and a load controller, for regulating delivery of electrical energy to, and absorption of electrical energy from, a power grid. The control unit may comprise a conversion interface electrically coupled to the conversion unit. The conversion interface may be configured to send controlling signals to the conversion unit and to receive status signals from the conversion unit. The control unit may further comprise a load gate interface electrically coupled to a load gate, the load controller interface being configured to send controlling signals to the load gate and to receive status signals from the load gate. The control unit may further include one of: an alternating power interface coupled to the power grid and configured to create a signal representing the power grid frequency, and a network interface coupled to a network to which a grid operator is connected. The interface may be configured to receive a power dispatch command from the grid operator. The control unit may further include a processor electrically coupled to the conversion interface and the load controller interface. The processor may be configured to execute stored instructions directed to selectively control power, as a function of one of a signal from the power grid and power grid operator dispatch command, and a parameter associated with the energy storage bank, (i) from the power grid through the conversion unit to the storage device, (ii) from the power grid through the load gate to the load, and (iii) from the storage device through the conversion device to the power grid.

In one embodiment, the processor may cause at least one of the storage bank and the load to receive electrical energy from the power grid when the signal from the power grid or the power grid operator's dispatch command conveys a requirement to absorb electrical energy, and the processor may cause the storage bank to deliver electrical energy to the power grid through the conversion unit when the signal from the power grid or the power grid operator's dispatch command conveys a requirement to deliver electrical energy.

In another embodiment the processor may be configured to, when the signal from the power grid or the power grid operator's dispatch command conveys a requirement to absorb electrical energy, cause the conversion unit to distribute the electrical energy to be absorbed from the power grid to the storage bank when the parameter associated with the energy storage bank does not exceed a threshold, and distribute the electrical energy to be absorbed from the power grid to the load when the parameter associated with the energy storage bank exceeds the threshold.

In another embodiment, the processor may be configured to interpret the signal from the power grid through an alternating power interface according to an energy response requirement that specifies an amount of power to be absorbed and an amount of power to be delivered, as a function of a frequency associated with the power grid.

In one embodiment, the load gate may be coupled to a useful load, and the processor may be configured to selectively control power through the load controller from the power grid to the useful load.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 shows an example of a prior art storage element-based reserve energy station.

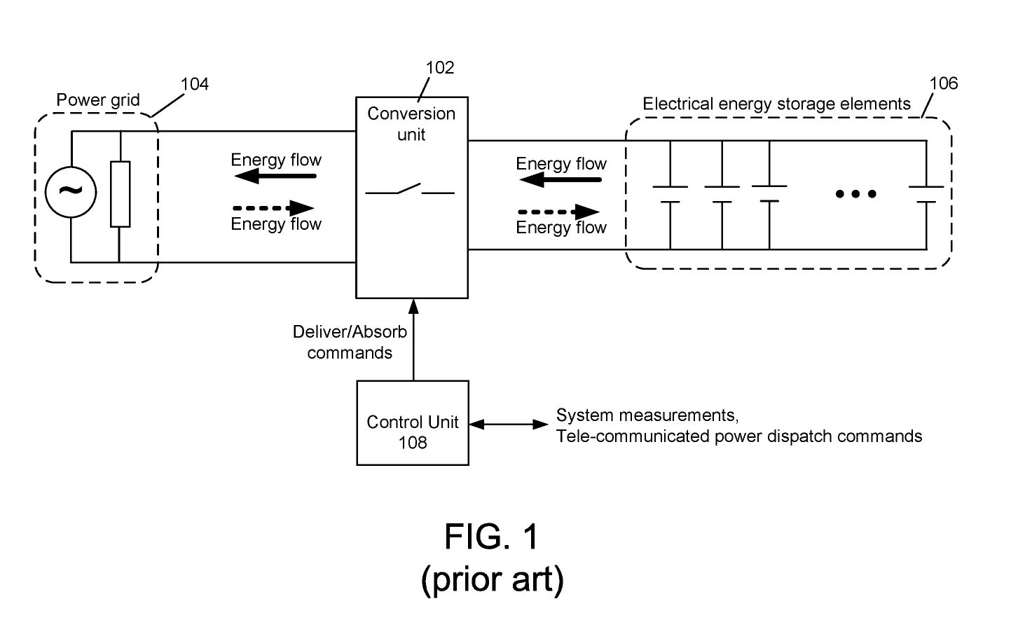

FIG. 2 shows an example frequency response requirement applicable to the system of FIG. 1.

FIG. 3A illustrates an example embodiment of an energy storage system according to the invention.

FIG. 3B illustrates a flow chart that illustrates a procedure for utilizing a load in an example embodiment of an energy storage system.

FIG. 3C is a flow chart that illustrates another procedure for utilizing a load in an example embodiment of an energy storage system.

FIG. 4 illustrates an example energy storage system with a frequency response requirement, according to the invention.

FIG. 5 shows simulated life degradation curves for Li-ION storage elements with and without a supplemental load according to the invention.

FIG. 6 illustrates an example embodiment of an ESSCU, depicted in FIG. 3A.

### DETAILED DESCRIPTION OF THE INVENTION

A description of example embodiments of the invention follows.

The teachings of all patents, published applications and references cited herein are incorporated by reference in their entirety.

The described embodiments are directed to an energy storage system that may respond to variations in a power grid by delivering stored energy to the power grid or by absorbing energy from the power grid. Energy delivery and absorption may be performed based on information from the power grid itself, and/or parameters associated with the energy storage bank within the energy storage system.

For energy absorption, a dissipative load (also referred to herein as a load) may be used instead of or in addition to energy storage capacity. A load operates by dissipating energy received from the power grid rather than storing it. The energy storage system may accomplish absorption of energy from the power grid by providing the energy to a storage bank, to a dissipative load, or to both. Further, reducing grid energy directed to a load may have the net effect of delivering energy to the power grid, so in some embodiments a load may be used to effectively deliver energy to a grid.

The use of a load to perform at least part of the absorption requirements of the energy storage system may reduce the cost of the energy storage system by reducing the energy storage requirements of the energy storage system. The use of a load to perform at least part of the absorption requirements of the energy storage system may further extend the life of the constituent energy storage elements by preventing some parameters associated with the energy storage bank from reaching values that may cause damage or premature capacity fading of the storage bank.

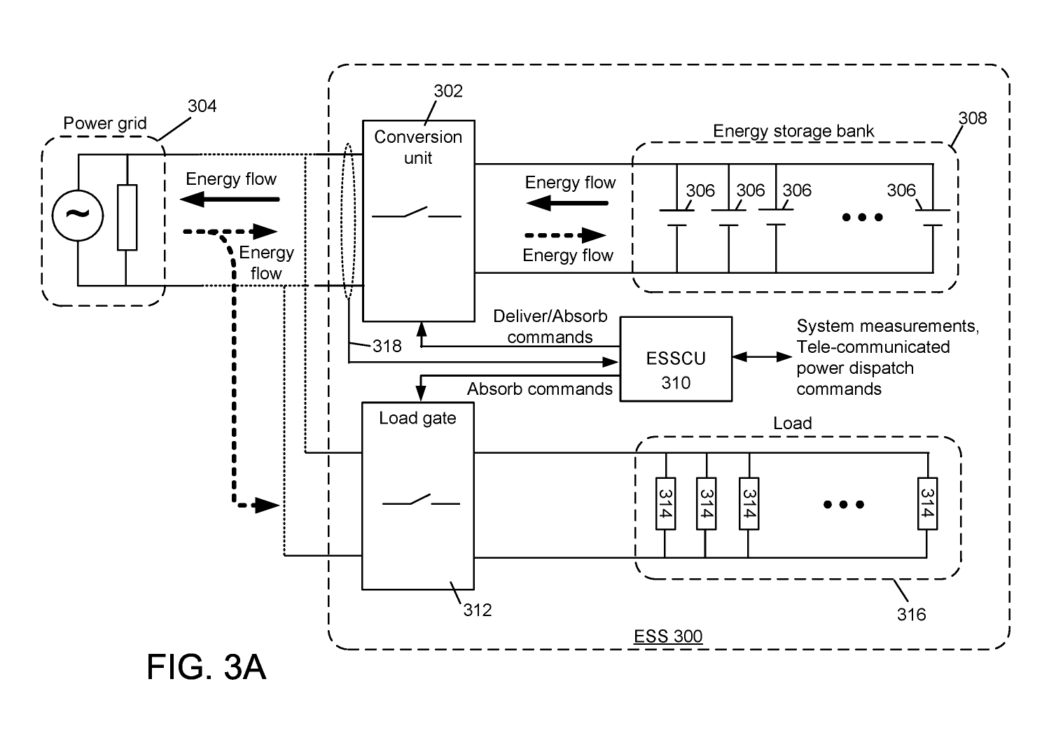

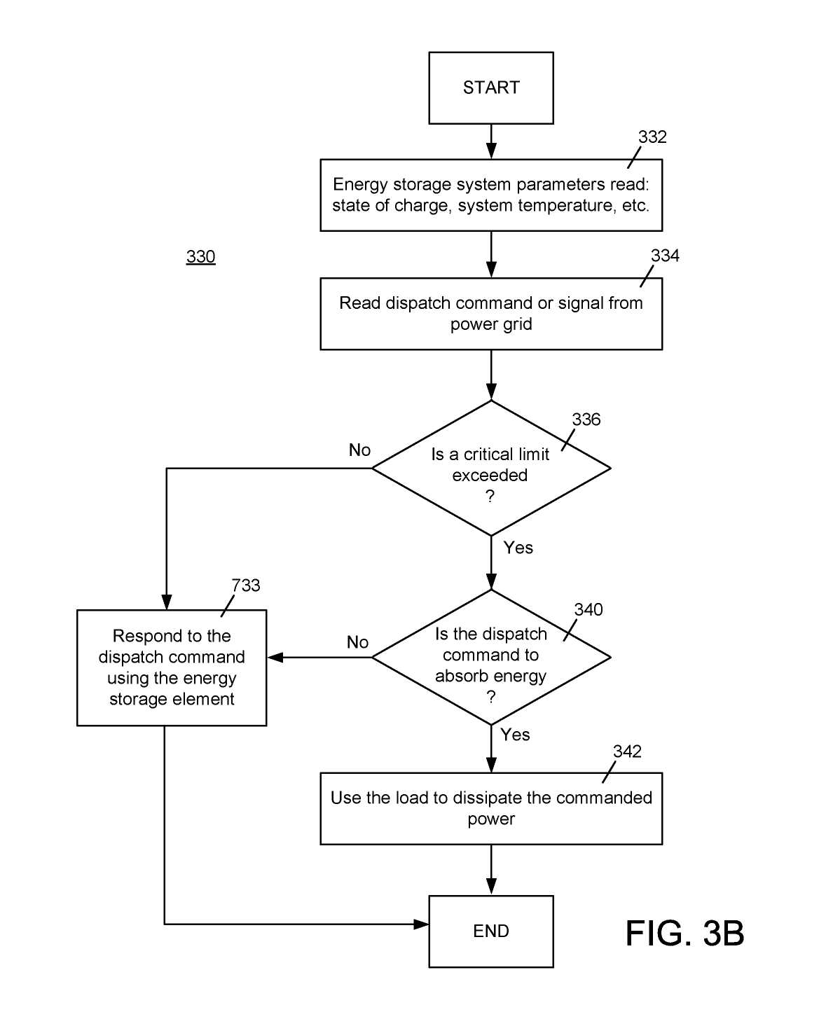

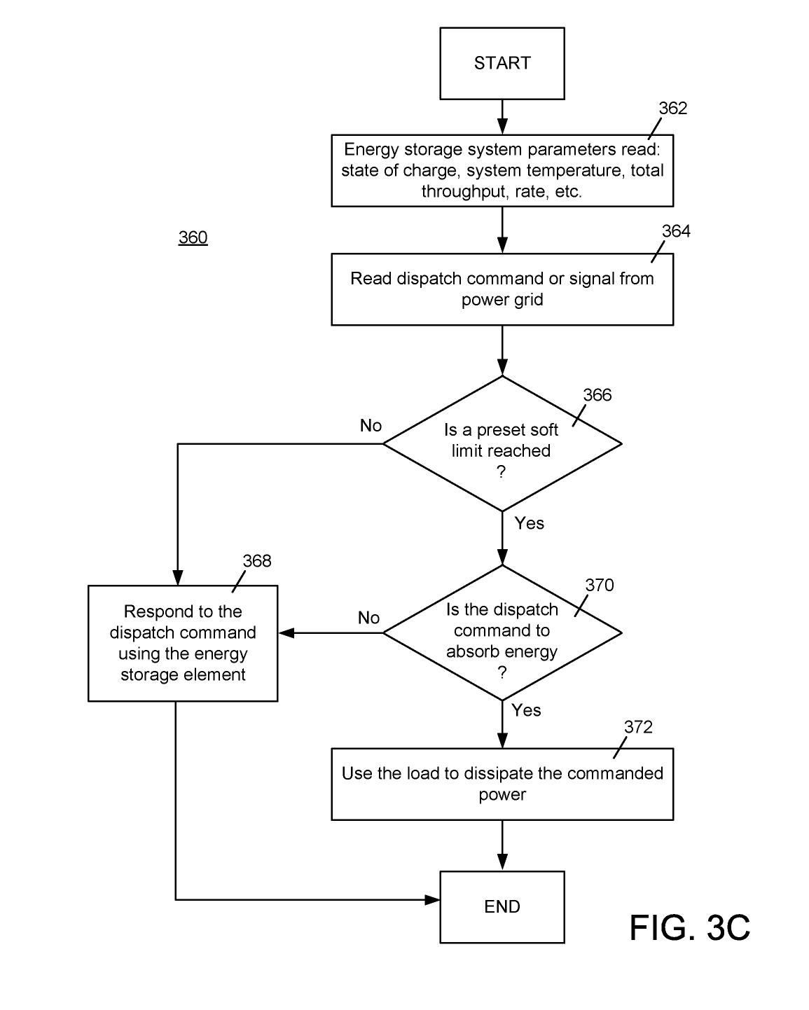

FIG. 3A illustrates an example embodiment of a energy storage system, according to the invention, that delivers energy to and absorbs electrical energy from a power grid.

An energy storage system is required to have sufficient capacity to absorb an amount of energy from the power grid (referred to herein as absorption capacity), the specific amount defined by an agreed-upon frequency response requirement. In the described embodiments, the absorption capacity may be shared by an energy storage bank and a dissipative load, thereby reducing the energy storage bank capacity as compared to a system that relies on power grid absorption by a storage bank alone.

FIG. 3A illustrates an example embodiment of an energy storage system (ESS) 300 according to the invention. An energy conversion unit 302 may connect a power grid 304 to a set of energy storage elements 306, referred to collectively as the energy storage bank 308. The energy conversion unit 302 provides, among other functions, conversion between the alternating current (AC) domain of the power grid to the direct current (DC) domain of the energy storage elements. Each electrical storage element 306 is capable of storing (i.e., absorbing) and discharging (i.e., delivering) electrical energy. Although the example embodiment of the ESS 300 illustrated in FIG. 3A shows the electrical storage elements 306 connected in parallel, it should be understood that the electrical storage elements 306 may be alternatively connected in series, or in a combination of series and parallel connections to form the energy storage bank 308. The storage elements 306 may include electro-chemical devices for storing electrical energy, such as Lithium-Ion batteries. In general, as referred to herein, a storage element may be any component that can store electrical energy from the power grid and can return the stored electrical energy to the power grid.

An energy storage system control unit (ESSCU) 310 may provide “deliver” and “absorb” commands to the conversion unit 302. The deliver and absorb commands may be generated as a function of a signal from the power grid and/or a parameter associated with the energy storage bank 308.

The signal from the power grid may be an alternating power signal 318 (e.g., voltage and/or current), so that the deliver and absorb commands are derived from power grid measurements (e.g., frequency of power grid). Alternatively or in addition, the deliver and absorb commands may be derived from tele-communicated power dispatch commands (e.g., an area control error (ACE) signal) from authorities maintaining the power grid (e.g., an independent service operator (ISO) such as California ISO or New England ISO), herein referred to as the grid operator.

The conversion unit 302 responds to an absorb command by allowing electrical energy to flow from the power grid 304 to the energy storage bank 308, thereby charging the energy storage bank 308. The conversion unit 302 responds to a deliver command by allowing electrical energy to flow from the energy storage bank 308 to the power grid, thereby discharging the energy storage bank 308. If the conversion unit 302 receives neither an absorb command nor a deliver command, the conversion unit may opportunistically charge or discharge the energy storage bank 308, at rates allowable by the grid operator, in order to manage the SOC at a desired set-point, such as 50%.

The ESS 300 may further include a load gate 312 that connects the power grid 304 to a set of dissipative load elements 314, collectively referred to herein as the load 316. In one embodiment, the load elements 314 may be resistive elements that convert electrical energy passing through them into heat to be dissipated into the ambient environment. In other embodiments, the dissipative load 316 may comprise a useful load such as a building heat or air conditioning system. As used herein, a “dissipative load” refers to an energy sink that consumes electrical energy and cannot return the absorbed energy back to the power grid.

The ESSCU 310 may provide absorb commands to the load gate 312, generated based on parameters associated with the energy storage bank, as described above for use by the conversion unit 302. The load gate 312 responds to an absorb command by allowing electrical energy to flow from the power grid 304 to the load 316, which the load 316 may dissipate as heat and/or as useful work.

Embodiments of an energy storage system may be used to reduce the required energy storage capacity of the energy storage system. Decisions as to when to direct energy to the load rather than the energy storage bank may be made by the system based on a parameter associated with the energy storage bank exceeding a critical limit. Examples of such parameters that have an associated critical limit may include state of charge and temperature, among others, or combinations of these parameters. A critical limit may be defined as a limit that, if exceeded, may lead to a severe degradation of the capacity and service life of the energy storage bank.

FIG. 3B illustrates a flow chart that illustrates a procedure 330 for utilizing a load in an example embodiment of an energy storage system to extend the life of the constituent storage bank. This procedure may be repeated for every execution of the ESSCU control loop. The procedure begins by reading 332 certain parameters associated with the energy storage bank, such as SOC and system temperature, and reading 334 a dispatch command or a signal from the power grid. If it is determined 336 that a critical limit of a parameter associated with the energy storage bank has not been exceeded, the energy storage system responds 338 by absorbing or delivering energy using the energy storage bank, depending on the dispatch command or signal from the power grid. If it is determined 336 that a critical limit of a parameter associated with the energy storage bank has been exceeded, the energy storage system determines 340 if the dispatch command or the signal from the power grid indicates a requirement to absorb energy. If the dispatch command or the signal from the power grid does not indicate a requirement to absorb energy, the energy storage system responds 338 by using the energy storage bank to deliver the commanded energy. If the dispatch command or the signal from the power grid indicates a requirement to absorb energy, the energy storage system responds 342 by using the load to dissipate the commanded energy.

Referring to the previously mentioned example, a 10 MW/10 MWh energy storage system with a 10 MW load, modified according to the described embodiments, would no longer need to have the 5 MWh of discharged storage capacity dedicated for energy accepting (i.e., absorb) events. That portion of previously dedicated storage capacity can be significantly reduced or totally eliminated. Hence, the storage capacity of the system can be decreased by up to 50% to be a 10 MW/5 MWh energy storage system if equipped with a 10 MW load. A storage bank/load hybrid system of the example embodiment assures full compliance to the specified frequency response requirement. The SOC of this example embodiment of an energy storage system (i.e., energy storage capacity reduced by 50%) is maintained at approximately 100% compared with 50% with the 10 MW/10 MWh energy storage system. This is because that instead of using 50% of the energy storage capacity to absorb grid energy when called upon to do so, the hybrid storage/load system can use the load to dissipate grid energy. Similarly, an example embodiment with the energy storage capacity reduced by 25%, the SOC would be maintained at 67%. A dissipative load is significantly less expensive as compared with electrical storage, so the hybrid system of the example embodiment has significant economic advantages.

The addition of a load to an energy storage system may also extend the operation life of an energy storage system (e.g., Li-Ion Battery Systems). Storage bank capacity degrades as a function of time, energy throughput, and other parameters that characterize conditions associated with the storage bank's operation. The capacity degradation of the storage bank may be significantly decreased through the use of a load. The ESSCU 310 of the example embodiment shown in FIG. 3A may be configured to reduce energy absorption burden on the energy storage bank 308 by occasionally diverting grid energy to the load, based on a parameter associated with the energy storage bank exceeding a soft limit. Such an energy diversion reduces the overall energy throughput of the storage bank, which may ease the degradation profile of the storage bank that occurs as a result of energy throughput, thereby extending the service life of the storage bank.

A parameter associated with the energy storage bank to be constrained by a soft limit may be the state of charge (SOC) of the energy storage bank, since maintaining the SOC of the energy storage bank below a particular limit may reduce fading and/or damage of the energy storage bank over its lifetime. Another parameter associated with the energy storage bank to be constrained by a soft limit may be temperature of the energy storage bank, since maintaining the temperature of the energy storage bank below a particular limit may reduce fading of the energy storage bank over its lifetime. Another parameter associated with the energy storage bank to be constrained by a soft limit may be the charge rate of the energy storage bank, since maintaining the charge rate of the energy storage bank below a particular limit may reduce fading and/or damage of the energy storage bank over its lifetime. It should be understood that one or a combination of the above-mentioned parameters associated with the energy storage bank may be used to generate the deliver and absorb commands provided to the load gate 312. It should also be understood that the above-mentioned parameters associated with the energy storage bank are example and are not intended to be limiting. Other parameters known in the art to be indicative of aspects of an energy storage bank may be used alternatively or in addition to the parameters described herein.

FIG. 3C is a flow chart that illustrates a procedure 360 for utilizing a load in an example embodiment of an energy storage system to extend the life of the constituent storage bank. This procedure may be repeated for every execution of the ESSCU control loop. The procedure begins by reading 362 certain parameters associated with the energy storage bank, such as SOC, system temperature, total throughput, and charge/discharge rate, and reading 364 a dispatch command or a signal from the power grid. If it is determined 366 that a soft limit associated with a parameter associated with the energy storage bank has not been exceeded, the energy storage system responds 368 by absorbing or delivering energy using the energy storage bank, depending on the dispatch command or signal from the power grid. The soft limits are preset to values determined to facilitate extended life of the constituent energy storage bank. If it is determined 368 that a soft limit of a parameter associated with the energy storage bank has been exceeded, the energy storage system determines 370 if the dispatch command or the signal from the power grid indicates a requirement to absorb energy. If the dispatch command or the signal from the power grid does not indicate a requirement to absorb energy, but rather to deliver energy, the energy storage system responds 368 by using the energy storage bank to deliver the commanded energy. If the dispatch command or the signal from the power grid indicates a requirement to absorb energy, the energy storage system responds 372 by using the load to dissipate all or part of the commanded energy.

The reduction of the storage bank throughput depends on the load utilization, which may be modified based on factors such as engineering judgment and economical aspects. In an example embodiment, diversion of grid energy from the storage bank may be performed over a fraction of absorption events (i.e., N % of the events, where N is a number between 0 and 100), distributed uniformly over the absorption events. In another example embodiment, diversion of grid energy from the storage bank may be performed over a fraction of time (i.e., N % of the time, where N is a number between 0 and 100), distributed uniformly over time. In other embodiments, diversion of grid energy from the storage bank may be performed based on parameters associated with the energy storage bank such as storage bank temperature, number of charge/discharge cycles experienced by the storage bank (e.g., over the entire life of the storage bank and/or a specific time window), charge/discharge rate profile of the storage bank, charge level profile of the storage bank, or other relevant parameters associated with the energy storage bank.

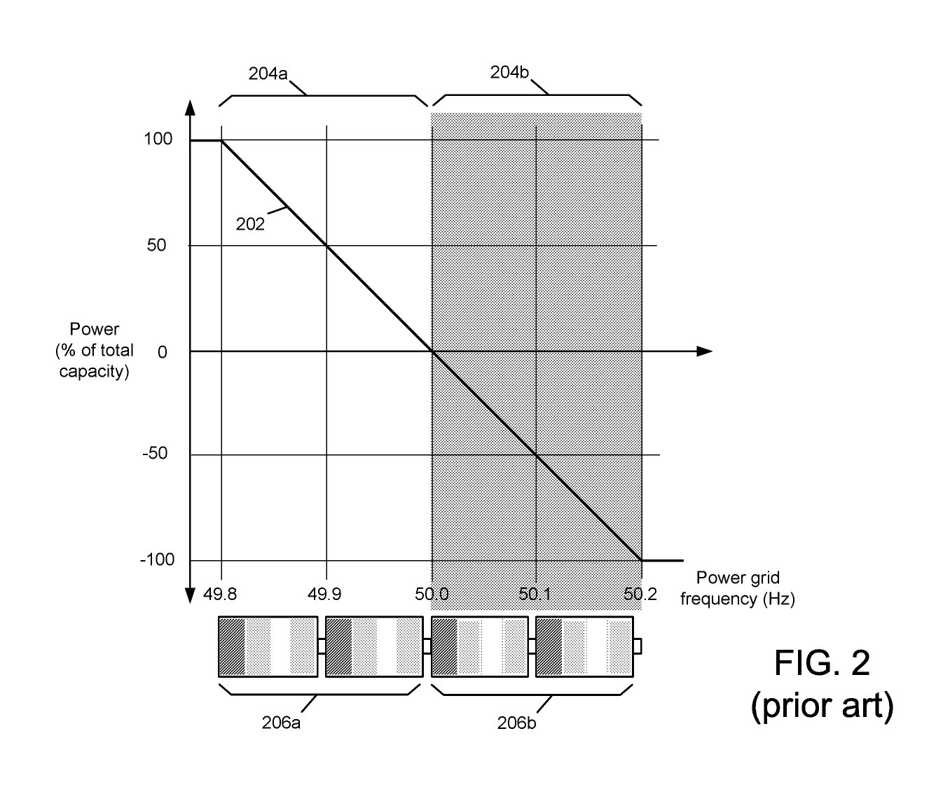

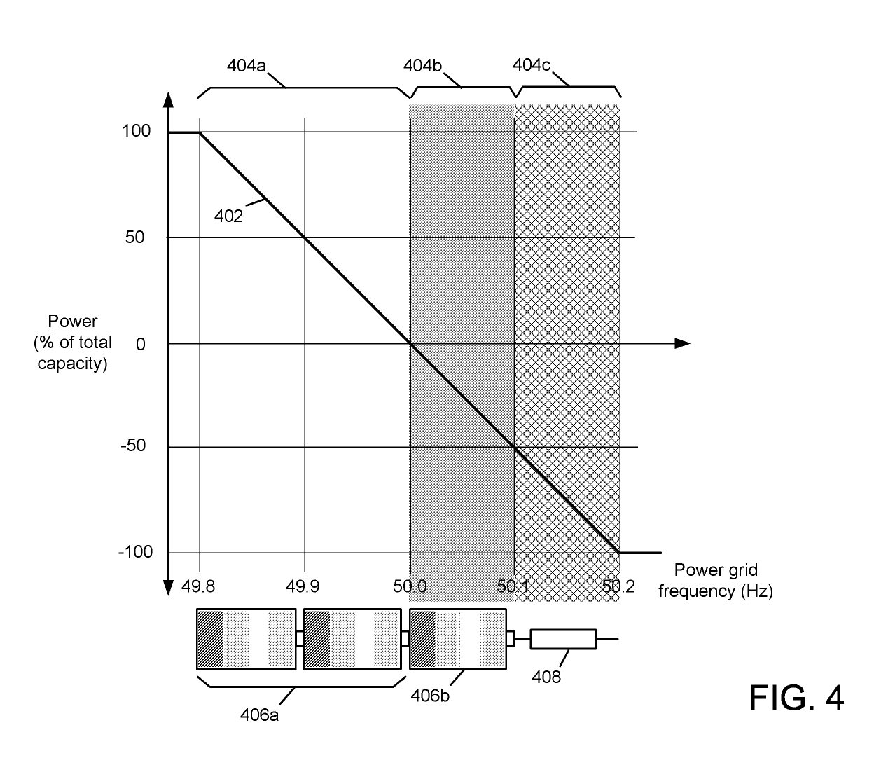

FIG. 4 illustrates an example power storage system with a frequency response requirement 402, similar to that shown in FIG. 2, but with one quarter of the energy storage bank capacity replaced with a dissipative load. As with FIG. 2, the capacity of the entire energy storage bank is shown conceptually by battery symbols 406a, 406b, and the battery symbols 406a, 406b are not intended to be construed as the configuration of actual cells in the storage bank. The unshaded region 404a designates the power grid frequency range for which the energy storage system delivers energy to the power grid from energy storage bank capacity 406a, the shaded region 404b designates the power grid frequency range for which the energy storage system absorbs energy from the power grid into energy storage bank capacity 406b, and the crosshatched region 404c designates the power grid frequency range for which the energy storage system absorbs energy from the power grid into load 408.

The unshaded region 404a designates the charged portion of the storage bank capacity 406a, 406b. The shaded region 404b designates the uncharged portion of the storage bank capacity 406a, 406b. The crosshatched region 404c designates the power absorption capacity of the load 406c. It should be understood that the SOC may be distributed across all of the elements of the energy storage bank, and not as shown with respect to conceptual battery symbols 406a, 406b that represent storage capacity. To satisfy the example system requirements for energy delivery, the SOC may be maintained at 66% of the storage bank capacity 406a, 406b.

A statistical frequency analysis of an example power grid demonstrates that, on average, the frequency of the example power grid is between 49.9 Hz and 50.1 Hz 99.94 percent of the time, and is between 50.1 Hz and 50.2 Hz only 0.025 percent of the time. The load 406c is therefore required to absorb a relatively small amount of energy.

Some embodiments may replace more of the absorbing energy storage bank capacity 406b with a dissipative load (i.e., more than the 25% shown in the example embodiment if FIG. 4). With such embodiments, a tradeoff exists between energy waste versus system economy, since replacing a portion of storage bank capacity 406b with a load places the load in the 50 Hz to 50.1 Hz range, resulting in a more substantial amount of absorbed energy being dissipated by the load. While increasing the load may waste more absorbed energy, the overall storage bank capacity 406a, 406b is smaller, which reduces the cost of the energy storage system.

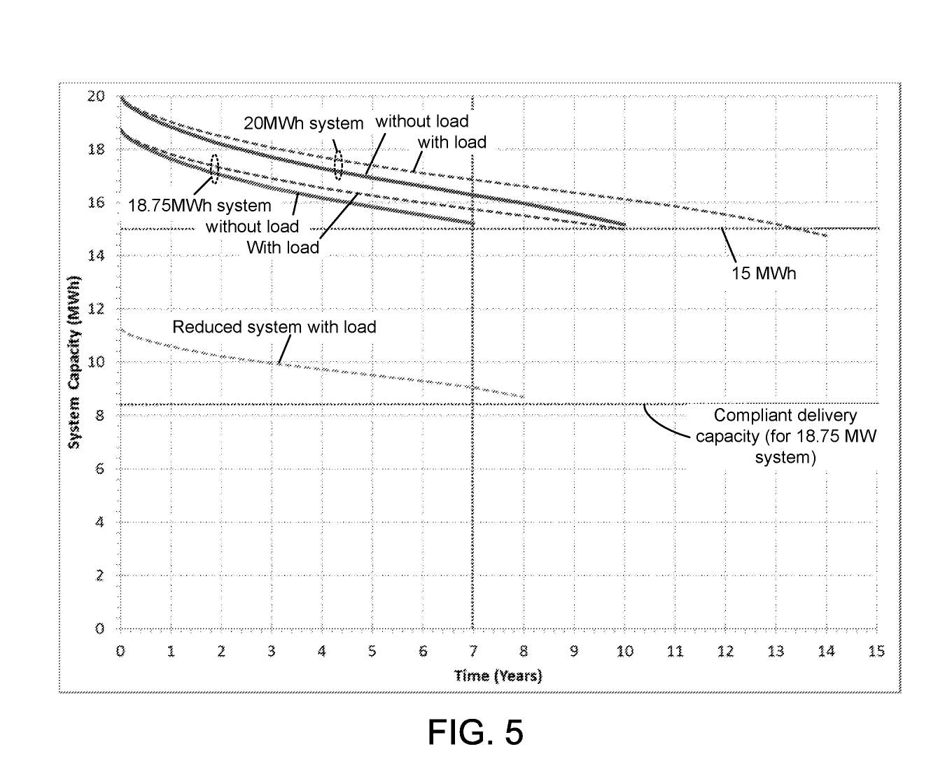

FIG. 5 shows simulated life degradation curves for a Li-ION storage bank with and without a supplemental load. These curves illustrate that utilizing a load to at least partially absorb grid energy may result in an extended operational life of the storage bank due to the decreased energy throughput, and hence, less severe life degradation. Furthermore, the curves also show a reduced system size (i.e., reduced energy storage capacity) to meet the same energy delivery requirements (e.g., for an 18.75 MW system requirement).

In some embodiments, all or a portion of the load 316 of FIG. 3 may be implemented with a useful load. As used herein, a “useful load” refers to a load that utilizes energy to be absorbed from the power grid to perform a useful, non-wasteful activity (i.e., other than merely converting the energy into heat to be released into the environment).

In one embodiment, a useful load may include a heating element in conjunction with a water reservoir (or a reservoir of other material having a suitably high specific heat). When the energy storage system is required to absorb energy from the power grid, and the energy storage system determines that the energy is to be diverted to the load, the energy storage system diverts some or all of that energy to the heating element. The heating element uses the power to heat the water (or other material) in the reservoir. The heated water may be used immediately, or at a later time, for a useful purpose such as heating a building.

In one embodiment, a useful load may include a building air conditioning system. In such an embodiment, particular arrangements may be established for such a configuration to harmonize the demand requirements of the energy storage system with the demands requirements of the building cooling services. For example, the building management may make certain timing concessions in exchange for energy pricing discounts, with respect to the energy delivered to run the air conditioning system.

In another embodiment, a useful load may include a refrigeration device configured to produce ice. Similar to the heated water example above, the generated ice may be used immediately or stockpiled for later use.

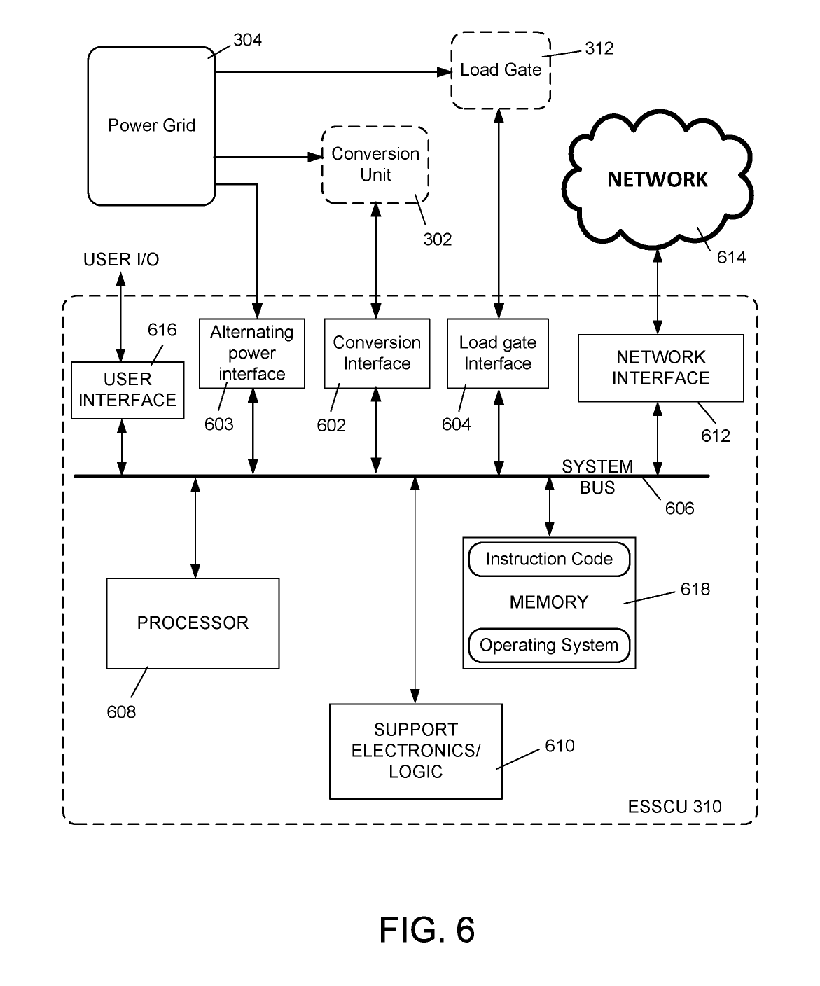

FIG. 6 illustrates an example embodiment of an ESSCU 310, depicted in FIG. 3A, for controlling the conversion unit 302 and the load gate 312. The example ESSCU 310 includes a conversion interface 602, which includes buffers, drivers and other communication components for sending deliver and absorb commands to the conversion unit 302, and for receiving status information from the conversion unit 302. The example ESSCU 310 includes a load gate interface 604, which includes buffers, drivers and other communication components for sending absorb commands to the load gate 312, and for receiving status information from the load gate 312. The example ESSCU 310 also includes an alternating power interface 603, which receives an alternating power signal from the power grid 304 and provides a derived signal to the system bus 606.

The conversion interface 602 buffers and formats information between the conversion unit 302, and the system bus 606. The load gate interface 604 buffers and formats information between the load gate 312, and the system bus 606. A processor 608 coordinates with the conversion interface 602 and the load gate interface 604 through the system bus to send deliver and absorb commands to the conversion unit 302 and absorb commands to the load gate 312. The processor 608 may also receive status information from the conversion unit 302 and the load gate 312 through the conversion interface 602 and the load gate interface 604, respectively. The processor receives the derived signals from the alternating power interface 603 through the bus 606 and may use the derived signals to determine characteristics of the power grid such as frequency.

The ESSCU 310 may also include support electronics/logic 610, a network interface 612 for communicating with an external network 614, and a user interface 616 for communicating user information between a system user and the system bus. The memory 618 may include an operating system to be executed by the processor for coordinating and managing the ESSCU and instruction code to be executed by the processor to perform the required functions of the ESSCU 310.

In one embodiment, the operating system and instruction code (shown as stored in memory 618) are a computer program product, including a non-transitory computer-readable medium (e.g., a storage medium such as one or more FLASH memory, hard disk drive (magnetic), optical storage, and other data storage media known in the art), that provides at least a portion of the instruction code for the described embodiments. The computer program product can be installed by any suitable software installation procedure, as is well known in the art.

While this invention has been particularly shown and described with references to example embodiments thereof, it will be understood by those skilled in the art that various changes in form and details may be made therein without departing from the scope of the invention encompassed by the appended claims.

What is claimed is:

1. An energy storage system that delivers electrical energy to and absorbs electrical energy from a power grid, comprising:
a storage bank configured to store electrical energy received from the power grid through a conversion unit, and to deliver stored electrical energy to the power grid through the conversion unit, the energy storage bank being characterized by a parameter associated with the energy storage bank;
a load configured to dissipate electrical energy received from the power grid through a load gate; and
a control unit operatively coupled to the conversion unit and the load gate, the control unit configured to control electrical energy flowing from the power grid to the energy storage bank and to the load, and electrical energy flowing from the energy storage bank to the power grid, as a function of (i) the parameter associated with the energy storage bank, and (ii) a signal from the power grid.

2. The system of claim 1, wherein the storage bank is characterized by a storage bank capacity, the load is characterized by a load dissipation ability, and the storage bank capacity is determined as a function of the load dissipation ability.

3. The system of claim 1, wherein the control unit causes at least one of the storage bank and the load to receive electrical energy from the power grid when the signal from the power grid conveys a requirement to absorb electrical energy, and the control unit causes the storage bank to deliver electrical energy to the power grid when the signal from the power grid conveys a requirement to deliver electrical energy.

4. The system of claim 3, wherein the control unit is configured to, when the signal from the power grid conveys a requirement to absorb electrical energy:
cause the electrical energy to be absorbed from the power grid to the storage bank through the conversion unit when the parameter associated with the energy storage bank does not exceed a parameter threshold; and
cause the electrical energy to be absorbed from the power grid to the load through the load gate when the parameter associated with the energy storage bank exceeds the parameter threshold.

5. The system of claim 3, wherein the control unit is configured to, when the signal from the power grid conveys a requirement to absorb electrical energy:
cause the electrical energy to be absorbed from the power grid to the storage bank N percent of the time, where N is a number between 0 and 100; and
cause the electrical energy to be absorbed from the power grid to the load 100 minus N percent of the time.

6. The system of claim 1, wherein the control unit is further configured to control electrical energy flowing from the power grid to the energy storage bank and to the load, and electrical energy flowing from the energy storage bank to the power grid, as a function of two or more parameters associated with the energy storage bank.

7. The system of claim 1, wherein the parameter associated with the energy storage bank is state of charge of the storage bank.

8. The system of claim 1, wherein the parameter associated with the energy storage bank is temperature of the storage bank.

9. The system of claim 1, wherein the parameter associated with the energy storage bank is total throughput of the system.

10. The system of claim 1, wherein the parameter associated with the energy storage bank is charge-discharge cycles experienced by the storage bank.

11. The system of claim 1, wherein the parameter associated with the energy storage bank is charge rate of the storage bank.

12. The system of claim 1, wherein the signal from the power grid is a dispatch command from the power grid operator indicating one of (i) absorb and (ii) deliver.

13. The system of claim 1, wherein the signal from the power grid is an alternating power signal at an interface with the power grid.

14. The system of claim 13, wherein the control unit is configured to interpret the alternating power signal according to an energy response requirement that specifies an amount of power the system has to absorb and an amount of power the system has to deliver as a function of a frequency associated with the alternating power signal.

15. The system of claim 1, wherein at least a portion of the load comprises a useful load that absorbs the received electrical energy by accomplishing a useful function.

16. A method of transferring energy to and from a power grid, comprising:
when a signal from the power grid indicates a requirement to deliver electrical energy, providing electrical energy to the power grid from an energy storage bank;
when the the signal from the power grid indicates a requirement to absorb electrical energy, performing, as a function of a parameter associated with the energy storage bank, at least one of (i) conveying electrical energy from the power grid to the energy storage bank and (ii) conveying electrical energy from the power grid to an electrical load.

17. The method of claim 16, further including interpreting the signal from the power grid according to an energy response requirement that specifies, as a function of a frequency associated with the power grid, an amount of energy to be absorbed and an amount of energy to be delivered.

18. The method of claim 16, further including conveying electrical energy to a load that absorbs received electrical energy by accomplishing a useful function.

19. The method of claim 16, further including conveying electrical energy from the power grid to the load when the control signal from the power grid indicates a requirement to absorb electrical energy, and a state of charge of the energy storage bank exceeds a threshold.

20. The method of claim 16, further including conveying electrical energy from the power grid to the load when the signal from the power grid indicates a requirement to absorb electrical energy, and a temperature of the energy storage bank exceeds a threshold.

21. The method of claim 16, further including conveying electrical energy from the power grid to the load when the signal from the power grid indicates a requirement to absorb electrical energy, and a total throughput of the energy storage bank exceeds a threshold.

22. The method of claim 16, further including conveying electrical energy from the power grid to the load when the signal from the power grid indicates a requirement to absorb electrical energy, and a number of charge-discharge cycles of the energy storage bank exceeds a threshold.

23. The method of claim 16, further including conveying electrical energy from the power grid to the load when the signal from the power grid indicates a requirement to absorb electrical energy, and a rate of electrical energy conveyances to the storage bank exceeds a threshold.

24. A control unit, associated with a storage bank, a load, a conversion unit, and a load controller, for regulating delivery of electrical energy to, and absorption of electrical energy from, a power grid, comprising:
a conversion interface electrically coupled to the conversion unit, the conversion interface being configured to send controlling signals to the conversion unit and to receive status signals from the conversion unit;
a load gate interface electrically coupled to a load gate, the load controller interface being configured to send controlling signals to the load gate and to receive status signals from the load gate; and
one of:
an alternating power interface coupled to the power grid, the interface being configured to create a signal representing the power grid frequency, and
a network interface coupled to a network to which a grid operator is connected, the interface being configured to receive a power dispatch command from the grid operator; and
a processor electrically coupled to the conversion interface and the load controller interface, the processor being configured to execute stored instructions directed to selectively control power, as a function of a signal from the power grid, and a parameter associated with the energy storage bank, (i) from the power grid through the conversion unit to the storage device, (ii) from the power grid through the load gate to the load, and (iii) from the storage device through the conversion device to the power grid.

25. The control unit of claim 24, wherein the processor causes at least one of the storage bank and the load to receive electrical energy from the power grid when the signal from the power grid conveys a requirement to absorb electrical energy, and the processor causes the storage bank to deliver electrical energy to the power grid through the conversion unit when the signal from the power grid conveys a requirement to deliver electrical energy.

26. The control unit of claim 24, wherein the processor is configured to, when the signal from the power grid conveys a requirement to absorb electrical energy:
cause the conversion unit to distribute the electrical energy to be absorbed from the power grid to the storage bank when the parameter associated with the energy storage bank does not exceed a threshold;
distribute the electrical energy to be absorbed from the power grid to the load when the parameter associated with the energy storage bank exceeds the threshold.

27. The control unit of claim 24, wherein the processor is configured to interpret the signal from the power grid through an alternating power interface according to an energy response requirement that specifies an amount of power to be absorbed and an amount of power to be delivered, as a function of a frequency associated with the power grid.

28. The control unit of claim 24, wherein the load gate is coupled to a useful load, and the processor is configured to selectively control power through the load controller from the power grid to the useful load.
